(19) United States
(12) Patent Application Publication
(10) Pub. No.: US 2026/0264655 A1
(43) Pub. Date: Sep. 10, 2026

(54) METHOD FOR CALIBRATING A BRAKING SYSTEM OF A VEHICLE, METHOD FOR OPERATING A BRAKING SYSTEM AND BRAKING SYSTEM

(71) Applicant: ZF Active Safety GmbH, Koblenz (DE)

(72) Inventor: Frank HELLER, Boppard (DE)

(21) Appl. No.: 19/541,461

(22) Filed: Feb. 17, 2026

(30) Foreign Application Priority Data
Mar. 5, 2025 (DE) 102025108416.5

(51) Int. Cl. B60T 13/66; B60T 7/04; B60T 8/172; B60T 8/48; B60T 13/68

(52) U.S. Cl. CPC B60T 13/662; B60T 7/042; B60T 8/172; B60T 8/4845; B60T 8/4872; B60T 13/686; B60T 2270/402; B60T 2270/604

(57) ABSTRACT

A braking system includes a primary braking module and a secondary braking module, wherein a pressure sensor, which detects a pressure in a supply line between an electro-fluidic pressure generating unit and the brake actuators, is present only in the primary braking module. In a method for calibrating the braking system, a pump in the secondary braking module is firstly calibrated using a pressure value specified by the electro-fluidic pressure generating unit and the valve is then calibrated using the calibrated pump. In a method for operating a braking system, the calibrated valve is controlled by specified calibration data in order to set a specified operating pressure when the secondary braking module is operated.

### TECHNICAL FIELD

The invention relates to a method for calibrating a braking system of a vehicle and to a method for operating a braking system and to a braking system.

### BACKGROUND

For particularly safety-relevant braking systems, such as in vehicles for highly autonomous driving, two independent braking modules are usually used, namely a primary braking module, which can brake the vehicle at any time in normal operation, and a secondary braking module, which ensures that, in the event of a defect in the primary braking module, the vehicle can still be braked safely.

The two braking modules usually communicate with each other and with a control unit via a data interface and are designed so that they can independently implement a braking request, which is transmitted via the interface, even without the driver depressing the brake pedal. For this purpose, the primary braking module normally has pressure sensors and a pressure actuator, which can set a pre-pressure, wherein a setpoint/actual comparison can be carried out via the pressure sensors. The pressure actuator can therefore adjust a hydraulic pressure with sufficient accuracy, regardless of the volume intake of the brake actuators.

The primary and secondary braking modules are also hydraulically connected to each other. In common configurations, both braking modules can operate independently of each other and also together, but the primary braking module always has priority when a brake pressure request or deceleration request is made. The secondary braking module typically only becomes active when the primary braking module has a fault or has failed completely.

However, sufficient pressure regulating accuracy is also expected of the secondary braking module in order to prevent over-braking, under-braking or yawing of the vehicle, for example. For this purpose, pressure sensors are often installed in the secondary braking module to control the pressure in the respective brake circuit and/or on the respective brake actuator. However, this is costly.

### SUMMARY

The object of the invention is to realize the generation of pressure in a secondary braking module in a cost-effective manner, but still with sufficient accuracy.

This object is achieved by a method for calibrating a braking system of a vehicle, wherein the braking system comprises a primary braking module and a secondary braking module, which are connected to pressure connections via a supply line. The primary braking module has an electro-fluidic pressure generating unit and a pressure sensor for a pressure generated in a supply line by the electro-fluidic pressure generating unit and the secondary braking module has a pump for generating a pressure in the supply line. The primary braking module and the secondary braking module are flow-connected via a controllable valve and the supply line runs from the electro-fluidic pressure generating unit via the valve to the pressure connections. The electro-fluidic pressure generating unit is designed to set a pressure in the supply line to a constant value specified by a control unit and to receive a volume of hydraulic fluid. The method comprises the steps:
calibrate the pump in the secondary braking module using a pressure value specified by the electro-fluidic pressure generating unit, and then
calibrate the valve using the calibrated pump.

This method enables an operating pressure to be set with sufficient accuracy by the secondary braking module, without the aid of a pressure sensor in the secondary braking module. For example, a calibrated current/pressure characteristic curve of the valve can be acquired, wherein the specified pressure value in the supply line is then achieved by setting a current value in accordance with this characteristic curve.

It has been found that the generation of pressure by a braking system calibrated in this way is sufficiently accurate to dispense with active pressure control in the secondary braking module. Pressure measurement in the secondary braking module or in the region of the individual brake actuators is thus unnecessary and it is possible to save on corresponding pressure sensors.

Reference data relating to the pump motor are recorded during the calibration of the pump, for example. The valve is optionally opened as far as possible here.

During the calibration of the valve, measurement data of the pump motor are then recorded, for example, which describe the opening angle of the valve to be calibrated.

The firstly calibrated pump (more precisely the motor of the pump) of the secondary braking module acts as a substitute for a pressure sensor during the calibration of the valve. The electrical and hydraulic power of the pump are compared with each other in both calibrations, for example, and should correspond with each other if the specified pressure value and, for example, the speed of the pump were equal in both calibrations. If this equality exists, it can be concluded that the valve to be calibrated is actuated with the correct operating parameters.

Both the measurements during the calibration of the pump and those during the calibration of the valve are carried out optionally quasi-statically with a constant flow of hydraulic fluid through the supply line and a constant pressure in the supply line.

The calibration of the pump comprises, for example, the steps:
regulate the pump to the specified pressure value while the specified pressure value is kept constant by the electro-fluidic pressure generating unit and the electro-fluidic pressure generating unit receives the volume delivered by the pump, and
acquire and store pump operating parameters for the specified pressure value as calibrated pump operating parameters.

By way of example, variables which can be acquired or calculated in a simple and cost-effective manner, for instance speed of the pump, voltage, current, electrical power, and/or electrical energy, can be used as pump operating parameters.

A flow rate through the pump and/or a time profile of the volume intake can be acquired by the electro-fluidic pressure generating unit, for example, and can be included in the calibration of the pump.

The hydraulic power is proportional to the product of the flow rate and pressure, while the electrical power is calculated from the product of the current and voltage of the pump motor. With a constant pressure and a constant flow rate, the electrical power therefore corresponds to the hydraulic power. The pump operation data and the pressure values can therefore be easily correlated.

The electro-fluidic pressure generating unit is, for example, a piston-cylinder unit with a piston that can be moved in both directions.

The calibration of the valve can comprise the steps:
set the valve with stored valve operating parameters for an expected pressure value,
operate the pump with at least one calibrated pump operating parameter for the expected pressure value,
acquire current pump operating parameters,
detect a deviation of the current pump operating parameters from the calibrated pump operating parameters for the expected pressure value,
determine calibration data for the valve from the deviation, and
correct the stored valve operating parameters with the calibration data.

The acquired calibration data are included in new pre-set valve operating parameters. Therefore, the currently valid calibrated pump operating parameters and calibration data for the valve are always used when the secondary braking module is operated.

Suitable valve operating parameters are, for example, coil current, voltage and/or electrical power of a valve actuator.

A correction factor for a coil current of the valve, for example, is ascertained and stored as calibration data for the valve. By way of example, during the calibration, the electrical power of the pump and the flow rate specified by the electro-fluidic pressure generating unit produce a calibrated pressure in the braking system, which is compared with the pre-set pressure value of the valve. The correction factor can be used to correct a deviation.

The expected pressure value can be easily set, for example, through appropriate selection of the pump operating parameters used for control, e.g. a specified speed, and suitable valve operating parameters, e.g. a coil current.

The calibrated pump operating parameters and calibration data for the valve which result from the calibration method, e.g. in the form of a correction factor, can be stored in a non-volatile memory of a suitable control unit for access during the operation of the braking system. The ascertained calibrated pump operating data, valve operating parameters and/or calibration data for the valve are then used during operation of the secondary braking module to actuate the valve, e.g. to energize the valve coil.

During the calibration, the outflow of hydraulic fluid to the brake actuators and to a hydraulic fluid reservoir is normally prevented. Therefore, the hydraulic fluid delivered by the pump can optionally be received completely by the electro-fluidic pressure generating unit under controlled circumstances. The volume intake of the electro-fluidic pressure generating unit corresponds, for example, to the behaviour of the brake actuator in normal operation, so that the specified pressure value can correspond to a pressure applied in normal operation of the braking system.

By way of example, only one or more discrete pressure-pump operating parameter pairs, e.g. pressure-speed pairs, are measured during the calibration. However, a complete characteristic curve can also be acquired.

It is possible to use the same specified pressure value in both phases of the calibration so that the pump and valve need only be optionally measured and calibrated for a single pressure value or a few different specified pressure values.

The calibration of the pump and the calibration of the valve can both be repeated multiple times during the life of the vehicle so that ageing processes of the components of the braking system can also be compensated.

The above object is also achieved by a method for operating a braking system, which comprises the following steps:
calibrate the pump and valve in accordance with a method described above, and
set an operating pressure when the secondary braking module is operated by specifying the calibration data for the valve for a specified pressure value.

Therefore, pressure control is not carried out during operation of the secondary braking module; rather, a pressure is simply set for which the calibration data ascertained via the calibration are used. For example, a valve operating parameter can be adapted to the actual current state of the braking system via a correction factor ascertained using the calibration data. It is thus possible to set the brake pressure with sufficient accuracy independently of a pressure sensor.

In general, the vehicle deceleration during a braking process is at least additionally controlled independently of the brake pressure, e.g. via the measured vehicle speed, so that the brake pressure need only be set with low accuracy. This required accuracy can be easily achieved via the described methods. Optionally, however, monitoring can be carried out by detecting a vehicle deceleration, which can be adaptively included in the corrections, for example.

In addition, the above object is also achieved by a braking system of a vehicle, which is designed to carry out a method described above, comprising a primary braking module and a secondary braking module, wherein the primary braking module and the secondary braking module define at least two brake circuits, which can each be coupled to at least one brake actuator via a pressure connection, and the pressure sensor in the primary braking module is the only pressure sensor which detects a pressure in the supply line between the electro-fluidic pressure generating unit and the brake actuators.

Due to the calibration, described above, of the pump and the valve of the secondary braking module, pressure sensors are not required in the secondary braking module, on the individual brake actuators or generally downstream of the secondary braking module. This reduces the cost of the braking system.

The electro-fluidic pressure generating unit is, for example, an electromotively adjustable plunger with a linearly movable piston and two fluid chambers arranged on opposite sides of the piston. Such plungers are fitted as standard in vehicle braking systems and are therefore often already available in the braking system, so additional components are not required.

### BRIEF DESCRIPTION OF THE DRAWINGS

The invention will be described in greater detail hereinafter on the basis of an exemplary embodiment with reference to the accompanying figures.

FIG. 1 schematically shows a braking system according to the invention for carrying out calibration and braking-system operation methods according to the invention,

FIG. 2 shows a schematic sequence of a method according to the invention for calibrating the braking system from FIG. 1; and

FIG. 3 shows a schematic sequence of a method according to the invention for operating the braking system from FIG. 1.

### DESCRIPTION

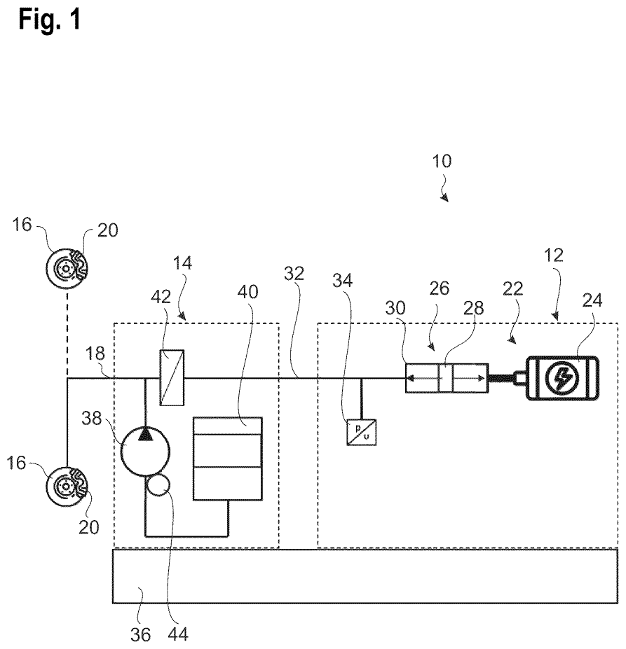

FIG. 1 shows a braking system 10 having primary braking module 12 and a secondary braking module 14.

The braking system 10 here is designed for a vehicle with four wheels 16 (rear right, front left, front right and rear left), of which only two are shown. All four wheels 16 can be braked using the braking system 10. For this purpose, the braking system 10 has several pressure connections 18 for brake actuators 20. The pressure connections 18 are allocated to two brake circuits, of which only one is shown here. The brake circuit shown here comprises the pressure connections 18 for the rear right and front left wheels 16. The second brake circuit (not shown) accordingly comprises the pressure connections for the front right and rear left wheels. Pressure can be optionally applied to and removed from each brake actuator 20 via the braking system 10.

To actuate the braking system 10, the vehicle here has a brake pedal (not shown), via which the driver can indicate a braking request which corresponds to a certain brake force and thereby a deceleration of the vehicle. In this example, the braking system 10 is designed for a brake-by-wire procedure. The braking request can therefore optionally also be triggered by a control unit of the vehicle, which serves for an autonomous driving function.

In both cases, the braking request is transmitted electronically, in a known manner, to an electro-fluidic pressure generating unit 22 of the braking system 10, which then provides the corresponding pressure in the braking system 10.

The electro-fluidic pressure generating unit 22 here is a known plunger and comprises an electric drive motor 24, which is drivingly coupled to a piston-cylinder unit 26 with a linearly movable piston 28.

The piston 28 is guided in a cylinder 30, wherein a fluid chamber is formed on both sides of the piston 28.

The fluid chambers can be supplied with hydraulic fluid from a hydraulic fluid reservoir (not shown) via a fluid line on the one hand and can feed hydraulic fluid under pressure into a supply line 32 on the other. In a known manner, this design also enables the piston 28 to feed hydraulic fluid under pressure into the supply line 32 both during a stroke in a direction away from the drive motor 24 and during a stroke in a direction towards the drive motor 24.

The piston-cylinder unit 26 here is also designed to receive hydraulic fluid from the supply line 32.

The electro-fluidic pressure generating unit 22 dispenses hydraulic fluid under a known pressure. A pressure sensor 34 is arranged in the supply line 32 and detects the hydraulic pressure actually set in the supply line 32.

The pressure sensor 34 and the drive motor 24 of the electro-fluidic pressure generating unit 22 are connected to a control unit 36, which receives sensor data from the pressure sensor 34 and which, among other things, can actuate the drive motor 24.

The control unit 36 is designed to specify a desired hydraulic pressure, also with a specified time profile, in the supply line 32 via the electrofluid pressure generating unit 22 and to actuate the drive motor 24 of the electrofluid pressure generating unit 22 accordingly for this purpose.

The electro-fluidic pressure generating unit 22 and the pressure sensor 34 are part of the primary braking module 12. The control unit 36 is connected to both the primary braking module 12 and the secondary braking module 14.

The supply line 32 runs from the primary braking module 12 through the secondary braking module 14 to the pressure connections 18.

The secondary braking module 14 comprises a pump 38, which can supply hydraulic fluid from a reservoir 40 to the supply line 32 under an adjustable pressure.

In the supply line 32, at least one valve 42 is also arranged, flow-wise, between the electro-fluidic pressure generating unit 22 and the pressure connection 18 and, with regard to the pressure connection 18, upstream of the pump 38. The pump 38 and valve 42 are part of the secondary braking module 14.

The pump 38 has a variable delivery rate. Accordingly, a variable pressure in the supply line 32 can be generated by the pump 38.

The valve 42 has a variable opening angle and therefore a variable flow rate and can therefore likewise influence the pressure in the supply line 32.

If the electro-fluidic pressure generating unit 22 fails, the secondary braking module 14 is designed to provide the necessary brake pressure at the pressure connections 18 via the pump 38 in an emergency operation in order to still enable controlled braking of the vehicle. Accordingly, the pump 38 and the valve 42 can build up a pressure in the supply line 32, which corresponds to the brake pressure used during normal operation of the braking system 10.

The control unit 36 can control both the pump 38 and the valve 42 and set the operating parameters thereof so that that the control unit 36 can also specify a pressure in the supply line 32 via the secondary braking module 14.

The pump 38 is equipped with suitable measuring devices 44 which detect, for example, a current through the pump motor, a voltage applied at the pump motor and/or a speed of the pump (more precisely the pump motor).

The speed is detected, for example, by a mechanical or inductive sensor or by other, more cost-effective measuring methods.

The control unit 36 determines, for example, an electrical power of the pump 38, a hydraulic power in the supply line 32, a volume flow rate through the supply line 32, and other suitable parameters from the acquired physical variables.

Both the primary braking module 12 and the secondary braking module 14 have further components, which are, however, not relevant for the explanation of the calibration and operating method described here and are assumed to be known. By way of example, further valves may be present in the secondary braking module 14. However, further pressure sensors are not provided on the brake actuators 20 or in the secondary braking module 14.

In the event of a brake pressure build-up by the secondary braking module 14, the control unit 36 actuates the valve 42 (which serves as an example here for all the valves involved in the secondary braking module 14). For this purpose, a suitable current is applied to a coil of the valve 42, which causes the valve 42 to open with a certain opening angle and hydraulic fluid to flow through the valve 42 at a corresponding flow rate. This ensures that a corresponding pressure is set in the supply line 32.

For this purpose, for example, a current/pressure characteristic curve which is typical for the component is used. In order to determine this characteristic curve or at least individual points of this characteristic curve with sufficient accuracy, the calibration method described below is carried out.

For example, the secondary braking module 14 decides when a calibration method should be started. In addition, this could also be requested via an external diagnostic command, for instance from the control unit 36.

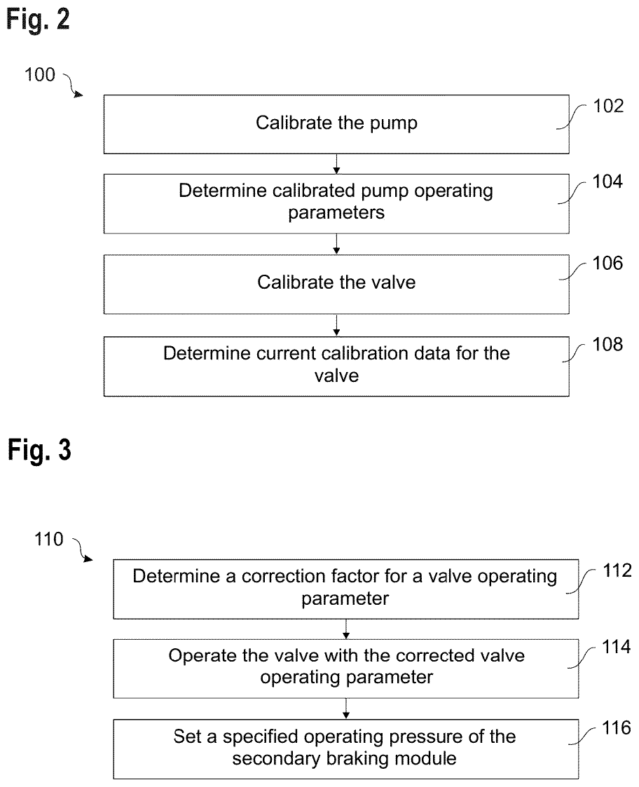

Firstly, the pump 38 is calibrated by a method 100 so that the pressure generated with specified pump operating parameters of the pump 38 is sufficiently accurately known (see steps 102, 104 in FIG. 2). For this purpose, a pressure value specified by the electro-fluidic pressure generating unit 22 is used and the current pressure in the supply line 32 is detected by the pressure sensor 34.

The valve 42 is then calibrated (see steps 106, 108 in FIG. 2), wherein the calibrated pump operating parameters determined in step 104 are used to operate the pump 38 and to obtain current calibration data for the valve 42.

During operation of the secondary braking module 14, the pressure can thus be set with sufficient accuracy via the calibrated pump operating parameters and calibration data for the valve 42, without using a pressure control procedure or currently measured pressure values.

The calibration is optionally carried out separately for each brake circuit or even for each brake channel of each brake circuit. For this purpose, the respective brake circuit or brake channel is flow-connected in isolation to the electro-fluidic pressure generating unit 22 in a known manner by setting the relevant valves of the braking system 10 accordingly.

To calibrate the pump 38, (with the valve 42 completely open), the control unit 36 of the electro-fluidic pressure generating unit 22 specifies a specified pressure value, which the electro-fluidic pressure generating unit 22 builds up in the supply line 32. The current pressure in the supply line 32 is detected by the pressure sensor 34 and used as a control variable for the specified pressure value during the calibration of the pump 38.

At the same time, the control unit 36 operates the pump 38 so that the pump 38 pumps hydraulic fluid in the corresponding brake circuit or brake channel in opposition to this pressure generated by the electro-fluidic pressure generating unit 22.

The control unit 36 now controls the operating parameters of the pump 38, e.g. current, voltage and/or speed, so that the pressure generated by the pump 38 corresponds to the specified pressure value.

By way of example, a speed of the pump is specified and the required operating current is detected. From this data, e.g. the hydraulic power and hydraulic energy applied by the pump 38 are calculated and these variables are correlated with the ascertained pump operating parameters, e.g. current and voltage. This establishes a relationship between the hydraulic and electrical power of the pump 38 at a specified pressure value (and known constant flow rate). The flow rate through pump 38 is obtained, for example, from the speed.

The fluid volume additionally pumped into the supply line 32 by the pump 38 is received by the electro-fluidic pressure generating unit 22 at a known, normally constant rate by moving the piston 28 successively in the direction of the drive motor 24. By way of example, the rate at which the hydraulic fluid is received is in the range of a flow rate through the braking system 10 to one of the pressure connections 18.

For this purpose, for example, at the beginning of the calibration of the pump 38, the piston 28 is moved to a suitable position (e.g. the central position), wherein pressure is not built up. This is achieved, for example, by simultaneously opening suitable relief valves while the piston 28 is moved.

The electro-fluidic pressure generating unit 22 keeps the specified pressure value sufficiently constant as a reference pressure over the entire calibration of the pump 38, even while the pump 38 pumps hydraulic fluid in opposition to the pressure generated by the electro-fluidic pressure generating unit 22. The pressure is measured with high frequency by the pressure sensor 34 and possibly suitably filtered and averaged.

The acquisition of pump operating parameters optionally takes place with high frequency over a certain time period. The acquired data are possibly suitably filtered and averaged.

The ascertained pump operating parameters for one or more specific specified pressure values are stored in relation to the respective specified pressure value in a non-volatile memory of the control unit 36.

To terminate the calibration of the pump 38, the electro-fluidic pressure generating unit 22 is deactivated again and the piston 28 is moved to a suitable position.

The valve 42 is then calibrated.

It is generally assumed that an offset of the valve 42 is already sufficiently accurately known.

During the calibration of the valve 42, an opening angle of the valve 42 is set via currently stored operating parameters and possibly already existing calibration data of the valve 42 to be calibrated and the pump operating parameters ascertained during the calibration of the pump 38, so that a specified pressure value, e.g. the specified pressure value just used during the calibration of the pump 38, should be reached. Optionally, a current, which is supplied to a coil of valve 42, is specified as the valve operating parameter.

The pump operating parameters are again acquired by the control unit 36, e.g. current, voltage and/or speed. These data are used to determine the electrical and the hydraulic power of the pump 38, for example.

A deviation in the opening angle of the valve 42 caused by a deviation in the current applied to actuate the coil of the valve 42 also results in a deviation in the pump operating parameters, e.g. in the electrical power applied by the pump 38 which is needed to set a specified speed of the pump 38.

In a variant, a correction factor for the current valve operating parameters is ascertained from the ratio for the measured and/or calculated physical variables, specifically for the hydraulic and electrical power, from the calibration of the pump 38 and the valve 42 (see step 112 in FIG. 3). This correction factor usually only affects the gain factor of the valve 42.

Since the correction factor is based on a ratio and the pump 38 is also used in the calibration of the valve 42, almost all interfering components cancel each other out as possible fault sources for the affected components of the braking system 10.

The correction factor is stored in the non-volatile memory of the control unit 36 and is used for the setting of the valve 42 until the next calibration.

To carry out a method 110 for operating the braking system 10, if the brake pressure is to be provided by the secondary braking module 14, then the respective valve operating parameter is corrected by the correction factor, e.g. the current to be applied according to the stored valve operating parameters is multiplied by the correction factor, in order to take into account the current calibration of the valve 42. The valve 42 is operated with the valve operating parameter corrected in this way (step 114).

With the actuation of the valve 42, an operating pressure of the secondary braking module 14 is therefore set with sufficient accuracy (step 116).

1. Method for calibrating a braking system of a vehicle,
wherein the braking system comprises a primary braking module and a secondary braking module which are connected to pressure connections via a supply line,
wherein the primary braking module comprises an electro-fluidic pressure generating unit and a pressure sensor for a pressure generated in a supply line by the electro-fluidic pressure generating unit and the secondary braking module has a pump for generating a pressure in the supply line and
the primary braking module and the secondary braking module are flow-connected via a controllable valve and the supply line runs from the electro-fluidic pressure generating unit via the valve to the pressure connections and
wherein the electro-fluidic pressure generating unit is designed to set a pressure in the supply line to a constant value specified by a control unit and to receive a volume of hydraulic fluid,
comprising the steps:
calibrate the pump in the secondary braking module using a pressure value specified by the electro-fluidic pressure generating unit, and then
calibrate the valve using the calibrated pump.

2. Method according to claim 1, wherein the calibration of the pump comprises the steps:
regulate the pump to the specified pressure value while the electro-fluidic pressure generating unit keeps the specified pressure value constant and the electro-fluidic pressure generating unit receives the volume delivered by the pump,
acquire and store pump operating parameters for the specified pressure value as calibrated pump operating parameters.

3. Method according to claim 2, wherein an electrical power, a voltage, a current, an electrical energy and/or a speed of the pump are used as pump operating parameters.

4. Method according to claim 2, wherein a flow rate through the pump and/or a time profile of the volume intake is acquired by the electro-fluidic pressure generating unit and included in the calibration of the pump.

5. Method according to any one of the preceding claims claim 1, wherein the calibration of the valve comprises the steps:
set the valve with stored valve operating parameters for an expected pressure value,
operate the pump with at least one calibrated pump operating parameter for the expected pressure value,
acquire current pump operating parameters,
detect a deviation of the current pump operating parameters from the calibrated pump operating parameters for the expected pressure value,
determine calibration data for the valve from the deviation, and
correct the stored valve operating parameters with the calibration data.

6. Method according to claim 5, wherein a coil current, a voltage and/or an electrical power are used as valve operating parameters.

7. Method according to claim 1, wherein a correction factor for a coil current of the valve is ascertained and stored as calibration data for the valve.

8. Method for operating a braking system, comprising the steps:
calibrate the pump and the valve in accordance with the method according to claim 1, and
set an operating pressure when the secondary braking module is operated by specifying the calibration data of the valve for a specified pressure value.

9. Braking system of a vehicle for carrying out a method according to claim 1, which comprises a primary braking module and a secondary braking module, wherein the primary braking module and the secondary braking module define at least two brake circuits, which can each be coupled to at least one brake actuator via a pressure connection , and the pressure sensor in the primary braking module is the only pressure sensor which detects a pressure in the supply line between the electro-fluidic pressure generating unit and the brake actuators.

10. Braking system according to claim 9, wherein the electro-fluidic pressure generating unit is an electromotively adjustable plunger with a linearly movable piston and two fluid chambers arranged on opposite sides of the piston.
